(19) United States
(12) Patent Application Publication
(10) Pub. No.: US 2008/0107390 A1
(43) Pub. Date: May 8, 2008

(54) METHOD FOR INTEGRATING A PLURALITY OF MULTIMEDIA DATA TO PRESENT A CORRESPONDING AUDIO-VISUAL PLAYBACK COMPLETELY AND AUDIO-VISUAL PLAYBACK SYSTEM THEREOF

(76) Inventor: Chang-Hung Lee, Yun-Lin Hsien (TW)

Correspondence Address: NORTH AMERICA INTELLECTUAL PROPERTY CORPORATION, P.O. BOX 506, MERRIFIELD, VA, 22116, US

(21) Appl. No.: 11/863,277

(22) Filed: Sep. 28, 2007

(30) Foreign Application Priority Data
Nov. 7, 2006 (TW) 095141145

(51) Int. Cl. H04N 5/91

(52) U.S. Cl. 386/66

(57) ABSTRACT

A method for integrating a plurality of multimedia data to present a corresponding audio-visual playback completely is disclosed. The method includes: (a) providing a first multimedia datum including video information; (b) retrieving a second multimedia datum via a network transmission; (c) integrating the first multimedia datum and the second multimedia datum; and (d) presenting an audio-visual playback corresponding to the first multimedia datum and the second multimedia datum according to an integrating result in step (c).

### BACKGROUND OF THE INVENTION

1. Field of the Invention

The present invention relates to a method for presenting an audio-visual playback and an audio-visual playback system thereof, and more particularly, to a method for integrating a plurality of multimedia data to present a corresponding audio-visual playback completely and an audio-visual playback system thereof.

2. Description of the Prior Art

Technology derives from humanity. Advancements in technology originate from the expectation for a better life. The storage and playback of audio-visual data are good examples of technological progress. If an audio-visual clip (i.e., a segment of AV content) can be recorded using a larger file volume, then the quality of the clip will be finer; more closely matching human requirements. Digital Versatile Disc (DVD) was intended as a benefit to the multimedia playback technology. DVD-Video was originally designed to meet the requirements of the movie industry, in particular, to provide a complete movie on a single “compact” optical disc. In the 1990s, several technology companies, such as Pioneer, Sony and Philips, started to develop a new digital video disc format, with the goal of recording two or more hours of high-quality video onto one disc, as a next-generation replacement for the LaserDisc (LD). In the end of 1995, Pioneer launched a digital versatile disc, called for short the DVD, a totally new type of optical storage media for storing video data. From then on, DVD becomes one of the most popular video storage media. The first DVD-Video player for playing video stored in a DVD went on sale shortly thereafter.

Since DVD was intended to replace LaserDisc (LD), DVD needed to provide at least equivalent video quality. As the result of many rounds of video quality evaluation, and with the assumption that DVD would use variable-rate video compression, it was determined that a data rate of 3.5 Mbps was the minimum requirement. Then, considering audio quality, flexibility for international use, and multimedia capability, it was decided to provide capacity for Dolby AC-3 audio in three languages (384 kbps×3) and subtitles in four languages (10 kbps×4), resulting in the design of a specification required a disc capacity of 4.7 GB. A DVD therefore has playback time of about 133 minutes, which is long enough to allow most movies to fit onto a single disc.

The files used for DVD-Video and DVD-Audio are arranged in directories called VIDEO_TS and AUDIO_TS respectively. The files in these directories have predetermined names and extensions. For example, files with the “.VOB” extension contain the actual video or audio content. A file with the “.VOB” extension may contains several data streams, such as a video data stream, an audio data stream, and a caption data stream. The video data stream may be in MPEG-2 type. The audio data stream may be in AC-3, Linear PCM, MPEG 2 multi-channel, or MPEG1 layer2 dual-channel types. Files with the extension “.IFO” contain application information needed to reproduce the content, such as guide information of introducing chapters or locating audio streams and caption streams. However all the above-mentioned multimedia files are stored in a single DVD for providing a complete audio-visual content, such as a complete movie. There is a limitation of business model for selling or renting a DVD with a complete audio-visual content, such as a movie.

### SUMMARY OF THE INVENTION

It is therefore a primary objective of the claimed invention to provide a method for integrating a plurality of multimedia data to present a corresponding audio-visual playback completely and an audio-visual playback system thereof for solving the above-mentioned problem.

According to the claimed invention, a method for integrating a plurality of multimedia data to present a corresponding audio-visual playback completely is disclosed. The method includes: (a) providing a first multimedia datum including video information; (b) retrieving a second multimedia datum via a network transmission; (c) integrating the first multimedia datum and the second multimedia datum; and (d) presenting an audio-visual playback corresponding to the first multimedia datum and the second multimedia datum according to an integrating result in step (c).

According to the claimed invention, an audio-visual playback system for integrating a plurality of multimedia data to present a corresponding audio-visual playback completely is disclosed. The audio-visual playback system includes a multimedia service terminal for providing multimedia data, an audio-visual presenting device for presenting audio-visual information, and a playback device. The playback device includes a receiving module for receiving a first multimedia datum including video information stored in a storage medium, a network transmission module for retrieving a second multimedia datum from the multimedia service terminal via a network transmission, a control module for integrating the first multimedia datum and the second multimedia datum so as to generate an audio-visual signal, and an output module for outputting the audio-visual signal to the audio-visual presenting device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG.1 is a functional block diagram of an audio-visual playback system according to a preferred embodiment of the present invention.

FIG.2 is a flowchart of integrating a plurality of multimedia data from a storage medium and a multimedia service terminal to present a corresponding audio-visual playback completely by an audio-visual presenting device according to the preferred embodiment of the present invention.

### DETAILED DESCRIPTION

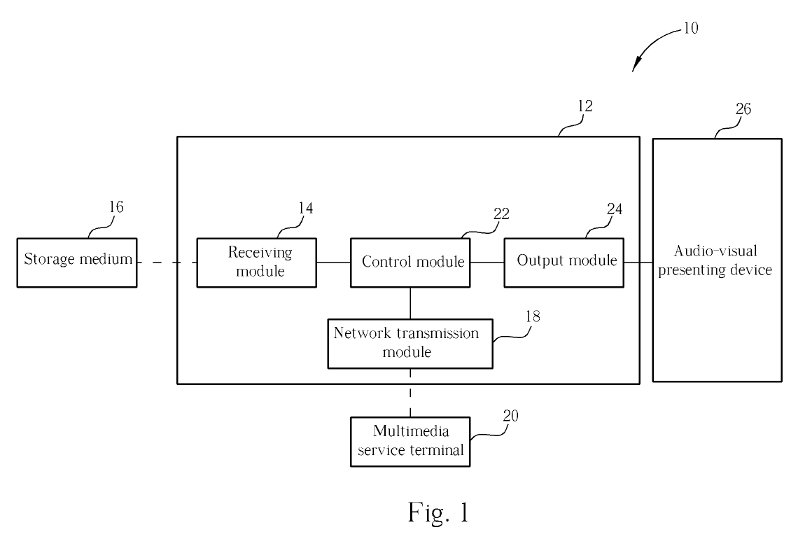

Please refer to FIG.1 . FIG.1 is a functional block diagram of an audio-visual playback system 10 according to a preferred embodiment of the present invention. The audio-visual playback system 10 includes a playback device 12. The playback device 12 may be a DVD player. The playback device 12 includes a receiving module 14 for receiving multimedia data stored in a storage medium 16. The storage medium 16 may be a VCD, DVD, and so on. The playback device 12 further includes a network transmission module 18 for connecting with a multimedia service terminal 20 via a network transmission. The multimedia service terminal 20 may be an Internet Services Provider (ISP) for providing multimedia audio-visual data. The playback device 12 further includes a control module 22 for integrating multimedia data received by the receiving module 14 and multimedia data retrieved by the network transmission module 18 so as to generate a corresponding audio-visual signal. The playback device 12 further includes an output module 24 for outputting the audio-visual signal generated by the control module 22 to an audio-visual presenting device 26. The audio-visual presenting device 26 presents a corresponding audio-visual playback according to an integrating result of the control module 22. The audio-visual presenting device 26 may be an apparatus for outputting images and sounds, such as a TV, a projector, a speaker, and so on.

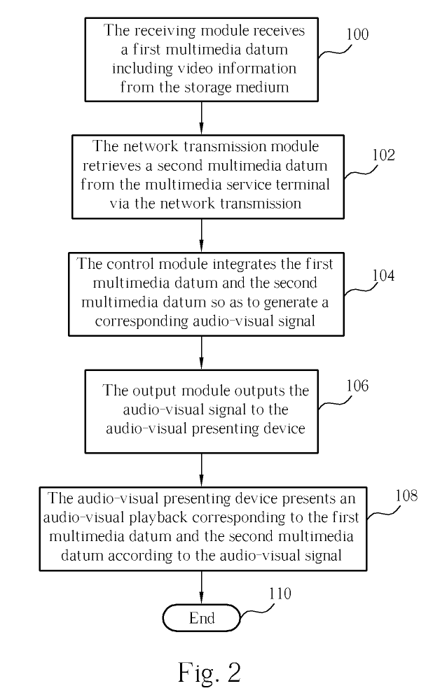

Please refer FIG.2. FIG.2 is a flowchart of integrating a plurality of multimedia data from the storage medium 16 and the multimedia service terminal 20 to present a corresponding audio-visual playback completely by the audio-visual presenting device 26 according to the preferred embodiment of the present invention. The method includes following steps:

Step 100: The receiving module 14 of the playback device 12 receives a first multimedia datum including video information from the storage medium 16.

Step 102: The network transmission module 18 of the playback device 12 retrieves a second multimedia datum from the multimedia service terminal 20 via the network transmission.

Step 104: The control module 22 of the playback device 12 integrates the first multimedia datum and the second multimedia datum so as to generate a corresponding audio-visual signal.

Step 106: The output module 24 of the playback device 12 outputs the audio-visual signal generated by the control module 22 to the audio-visual presenting device 26.

Step 108: The audio-visual presenting device 26 presents an audio-visual playback corresponding to the first multimedia datum and the second multimedia datum according to the audio-visual signal transmitted from the output module 24.

Step 110: End.

More detailed descriptions for the steps mentioned above will be provided. The storage medium 16 can store the first multimedia datum with video and audio information. For example, a file format of the first multimedia datum may be a Video Object (VOB) type. That is, the first multimedia datum may be a file with the “.VOB” extension. Additionally, the storage medium 16 can store the first multimedia datum with video information, and a file format of the first multimedia datum may be a MPEG type. The receiving module 14 of the playback device 12 can read the first multimedia datum from the storage medium 16 and transmit the first multimedia datum to the control module 22. Furthermore, the network transmission module 18 of the playback device 12 can retrieve the second multimedia datum from the multimedia service terminal 20 via the network transmission. For example, the network transmission module 18 can retrieve the second multimedia datum with a data stream algorithm via the network transmission and transmit the second multimedia datum to the control module 22. If the file format of the first multimedia datum is the Video Object (VOB) type, a file format of the second multimedia datum may be an IFO type. That is, the second multimedia datum may be a file with the “.IFO” extension. Files with the extension “.IFO” contain application information needed to reproduce the content, such as guide information of introducing chapters or locating audio streams and caption streams. If the first multimedia datum only includes the video information and does not include the audio information, the second multimedia datum may include the audio information corresponding to the video information of the first multimedia datum. If the first multimedia datum includes the video information and the audio information without caption information, the second multimedia datum may include the caption information corresponding to the video information and the audio information of the first multimedia datum. The second multimedia datum also may include a time stamp for synchronizing the video information and the audio information. The network transmission module 18 of the playback device 12 can retrieve the second multimedia datum from the multimedia service terminal 20 through a payment certificate authority via the network transmission. That is, the user has to pay for the authority in advance. Then the user can log in the multimedia service terminal 20 with the authority so as to retrieve the second multimedia datum corresponding to the first multimedia datum. For example, if the user gets the storage medium 14 with the first multimedia datum about a movie, the user can retrieve the second multimedia datum from the multimedia service terminal 20 by the network transmission module 18 via the network transmission. The second multimedia datum may include the file with the “.IFO” extension of the movie if the first multimedia datum includes the file with the “.VOB” extension of the movie. The second multimedia datum may include the audio information of the movie if the first multimedia datum includes the video information of the movie. The second multimedia datum also may include the caption information in a language of the movie if the first multimedia datum lacks for the caption information in the language of the movie. The multimedia service terminal 20 can charge for downloading the second multimedia with the payment certificate authority. The control module 22 of the playback device 12 integrates the first multimedia datum and the second multimedia datum so as to generate the audio-visual signal corresponding to the first multimedia datum and the second multimedia datum. The output module 24 of the playback device 12 outputs the audio-visual signal generated by the control module 22 to the audio-visual presenting device 26. The audio-visual presenting device 26 presents the complete audio-visual playback corresponding to the first multimedia datum and the second multimedia datum according to the audio-visual signal transmitted from the output module 24 so as to present the images, sounds, captions, and the related contents completely.

Besides dividing the complete multimedia data into two multimedia data (the first multimedia datum and the second multimedia datum), the complete multimedia data also may be divided into more multimedia data of the present invention. The plurality of multimedia data may be integrated into the corresponding complete multimedia data by means of reading the storage medium 16, retrieving from the multimedia service terminal 20, and so on.

In contrast to the prior art, the present invention divides the complete multimedia data into a plurality of multimedia data. Then the plurality of multimedia data may be obtained by means of reading the storage medium, retrieving from the multimedia service terminal, and so on so as to integrate the plurality of multimedia data into the corresponding audio-visual playback. The present invention not only provides another business model for selling or renting a storage medium, such as DVD or VCD, but also prevents the pirated crime because of the whole multimedia data being stored in a single storage medium.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for integrating a plurality of multimedia data to present a corresponding audio-visual playback completely, the method comprising:
(a) providing a first multimedia datum comprising video information;
(b) retrieving a second multimedia datum via a network transmission;
(c) integrating the first multimedia datum and the second multimedia datum; and
(d) presenting an audio-visual playback corresponding to the first multimedia datum and the second multimedia datum according to an integrating result in step (c).

2. The method of claim 1 wherein step (a) comprises providing a first multimedia datum comprising video and audio information.

3. The method of claim 2 wherein a file format of the first multimedia datum is a Video Object (VOB) type.

4. The method of claim 3 wherein a file format of the second multimedia datum is an IFO type.

5. The method of claim 1 wherein step (b) comprises retrieving the second multimedia datum comprising caption information via the network transmission.

6. The method of claim 1 wherein step (b) comprises retrieving the second multimedia datum comprising audio information via the network transmission.

7. The method of claim 6 wherein a file format of the first multimedia datum is a MPEG type.

8. The method of claim 1 wherein step (b) comprises retrieving the second multimedia datum with a data stream algorithm via the network transmission.

9. The method of claim 1 wherein step (b) comprises retrieving the second multimedia datum with a time stamp for synchronizing video information and audio information via the network transmission.

10. The method of claim 1 wherein step (b) comprises retrieving the second multimedia datum through a payment certificate authority via the network transmission.

11. An audio-visual playback system for integrating a plurality of multimedia data to present a corresponding audio-visual playback completely, the audio-visual playback system comprising:
a multimedia service terminal for providing multimedia data;
an audio-visual presenting device for presenting audio-visual information; and
a playback device comprising:
a receiving module for receiving a first multimedia datum comprising video information stored in a storage medium;
a network transmission module for retrieving a second multimedia datum from the multimedia service terminal via a network transmission;
a control module for integrating the first multimedia datum and the second multimedia datum so as to generate an audio-visual signal; and
an output module for outputting the audio-visual signal to the audio-visual presenting device.

12. The audio-visual playback system of claim 11 wherein the multimedia service terminal is an Internet Services Provider (ISP).

13. The audio-visual playback system of claim 11 wherein the first multimedia datum comprises video and audio information.

14. The audio-visual playback system of claim 13 wherein a file format of the first multimedia datum is a Video Object (VOB) type.

15. The audio-visual playback system of claim 14 wherein a file format of the second multimedia datum is an IFO type.

16. The audio-visual playback system of claim 11 wherein the second multimedia datum comprises caption information.

17. The audio-visual playback system of claim 11 wherein the second multimedia datum comprises audio information.

18. The audio-visual playback system of claim 17 wherein a file format of the first multimedia datum is a MPEG type.

19. The audio-visual playback system of claim 11 wherein the second multimedia datum comprises a time stamp for synchronizing video information and audio information.

20. The audio-visual playback system of claim 11 wherein the playback device is a DVD player.
